(19) United States
(12) Patent Application Publication
(10) Pub. No.: US 2026/0138502 A1
(43) Pub. Date: May 21, 2026

(54) RELEASE ACTUATOR FOR VEHICLE SEAT

(71) Applicants: DAS CO., LTD, Gyeongju-si (KR); DURING CO., LTD, Incheon (KR)

(72) Inventors: Byung Yoon CHOI, Seoul (KR); Kwang Sin LEE, Gyeonggi-do (KR); Kwang Su MOON, Gyeonggi-do (KR); Sung Won KANG, Incheon (KR); In Yong PARK, Incheon (KR); Byoung Ju JANG, Incheon (KR); Ji Haeng JUNG, Incheon (KR)

(21) Appl. No.: 18/991,581

(22) Filed: Dec. 22, 2024

(30) Foreign Application Priority Data
Nov. 21, 2024 (KR) 10-2024-0167499

(51) Int. Cl. B60N 2/02; B60N 2/12

(52) U.S. Cl. CPC B60N 2/02253; B60N 2/12

(57) ABSTRACT

The present disclosure relates to a release actuator capable of selectively converting at least one among a walk-in locking mechanism and a folding locking mechanism into a released state from a locked state according to a rotational direction of a rotational unit. The release actuator of a vehicle seat includes: a pair of first cables installed to release a walk-in locking mechanism; a second cable installed to release a folding locking mechanism; a rotating unit configured to apply tension independently and respectively to the first cable and the second cable based on a forward rotation and a reverse rotation; and a driving unit configured to provide a rotational force to the rotating unit in a forward direction and a reverse direction, and the rotating unit may include a forward interlocking rotating part configured to provide tension to one among the first cable and the second cable based on a forward rotation; and a reverse interlocking rotating part configured to provide tension to another one among the first cable and the second cable based on a reverse rotation.

This application claims the benefit of Korea Patent Application No. KR 10-2024-0167499, filed Nov. 21, 2024, the entire contents of which are incorporated by reference herein.

### FIELD OF THE INVENTION

The present disclosure relates to a release actuator of a vehicle seat, more particularly, to a release actuator capable of selectively converting at least one among a walk-in locking mechanism and a folding locking mechanism into a released state from a locked state according to a rotational direction of a rotational unit.

### BACKGROUND OF THE INVENTION

In general, a seat disposed in a second row or a third row of the vehicle has a walk-in device and a folding device so as to help getting on and off of the passengers.

At this instance, the walk-in device is configured to move the seat in a forward direction, and the folding device is configured to fold the seat back portion in a forward direction toward the seat cushion.

In particular, in case of the walk-in device, the locking mechanism is individually installed with respect to the seat rails on left and right sides in a single seat, therefore, the same tension must be provided to two cables installed in each of the locking mechanisms so as to operate the walk-in device.

To this end, conventionally, parts more than necessary are required for configuring the walk-in device because the tension provided to the two cables must be uniformly adjusted by using a separate part such as a distributor and the like.

### SUMMARY OF THE INVENTION

A technical object of the present is to provide a release actuator of a vehicle seat capable of selectively converting at least one among a walk-in locking mechanism and a folding locking mechanism into a released state from a locked state according to a rotational direction of a rotational unit.

One embodiment is a release actuator of a vehicle seat, including: a pair of first cables installed to release a walk-in locking mechanism; a second cable installed to release a folding locking mechanism; a rotating unit configured to apply tension independently and respectively to the first cable and the second cable based on a forward rotation and a reverse rotation; and a driving unit configured to provide a rotational force to the rotating unit in a forward direction and a reverse direction, and the rotating unit may include a forward interlocking rotating part configured to provide tension to one among the first cable and the second cable based on a forward rotation; and a reverse interlocking rotating part configured to provide tension to another one among the first cable and the second cable based on a reverse rotation, the forward interlocking rotating part and the reverse interlocking rotating part may be configured to be set in directions opposite to each other based on a rotational direction of the rotating unit.

As a preferred embodiment of the present disclosure, it is preferable that a forward-reverse interlocking invalid section configured to not to provide tension to the first cable and the second cable, respectively, in a forward direction and a reverse direction may be provided between the forward interlocking rotating part and the reverse interlocking rotating part.

As a preferred embodiment of the present disclosure, it is preferable that the rotating unit may include a rotating gear receiving a rotational force from the driving unit, and a rotating ring installed coaxially with a rotational center of the rotating gear and configured to set the forward interlocking rotating part and the reverse interlocking rotating part.

As a preferred embodiment of the present disclosure, it is preferable that the rotating ring may consist of at least a pair of members installed in a coaxial layered arrangement structure on both side surfaces about the rotating gear.

As a preferred embodiment of the present disclosure, it is preferable that the rotating gear may include a body part having a disk shape and a boss part protruding outward from a center of the body part, and the rotating ring may include a body part having a disk shape and a boss part protruding outward from a center of the body part, and the boss part of the rotating gear and the boss part of the rotating ring may be disposed at positions opposite to each other about the rotating gear.

As a preferred embodiment of the present disclosure, it is preferable that the rotating gear may include a tooth part configured to provide power to the driving unit and disposed along an outer circumferential surface of the body part.

As a preferred embodiment of the present disclosure, it is preferable that the rotating unit may include a first gap allowing the first cable to be inserted thereinto and disposed between one side surface of the rotating gear and a surface of one among the rotating rings opposite to the one side surface, and a second gap allowing the second cable to be inserted thereinto and disposed between another side surface of the rotating gear and a surface of another one among the rotating rings opposite to the another side surface.

As a preferred embodiment of the present disclosure, it is preferable that the rotating unit may further include a shaft coupling unit configured to coaxially connect the rotating gear and the rotating ring.

As a preferred embodiment of the present disclosure, it is preferable that the shaft coupling unit may include a recessed groove and a protrusion configured to coaxially couple the boss part of the rotating gear and the boss part of the rotating ring to each other with respect to the rotational center of the rotating unit.

As a preferred embodiment of the present disclosure, it is preferable that the recessed groove may be formed on an outer circumferential surface of boss part of the rotating gear, and the protrusion may be formed on an inner circumferential surface of the boss part of the rotating ring.

As a preferred embodiment of the present disclosure, it is preferable that the forward interlocking rotating part, the reverse interlocking rotating part and the forward-reverse interlocking invalid section may include an arcuate groove portion provided in each of the rotating gear and the rotating ring and a stepped portion provided in each of both ends of the arcuate groove portion, and the arcuate groove portion may movably accommodate a free end of the first cable and a free end of the second cable therein, and the stepped portion may be configured to contact and restrict the free end of the first cable and the free end of the second cable.

As a preferred embodiment of the present disclosure, it is preferable that the arcuate groove portion may be provided on a circumference of the boss part of the rotating gear in the body part of the rotating gear, and on a circumference of the boss part of the rotating ring in the body part of the rotating ring, and the arcuate groove portion may be stacked continuously with a same radius of curvature with respect to the rotational center of the rotating unit.

As a preferred embodiment of the present disclosure, it is preferable that each of a first end fitting provided in the free end of the first cable and a second end fitting provided in the free end of the second cable may be movably inserted into the arcuate groove portion, and may be installed to be in contact with the stepped portion.

The release actuator of a vehicle seat according to an embodiment of the present disclosure can selectively convert at least one among a walk-in locking mechanism and a folding locking mechanism into a released state from a locked state according to a rotational direction of a rotational unit, thereby a quantity of parts needed in configuring a device for converting an operation of the walk-in locking mechanism and the folding locking mechanism can be reduced and the manufacturing cost thereof can be saved.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112 (f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view illustrating a release actuator of a vehicle seat according to an embodiment of the present disclosure.

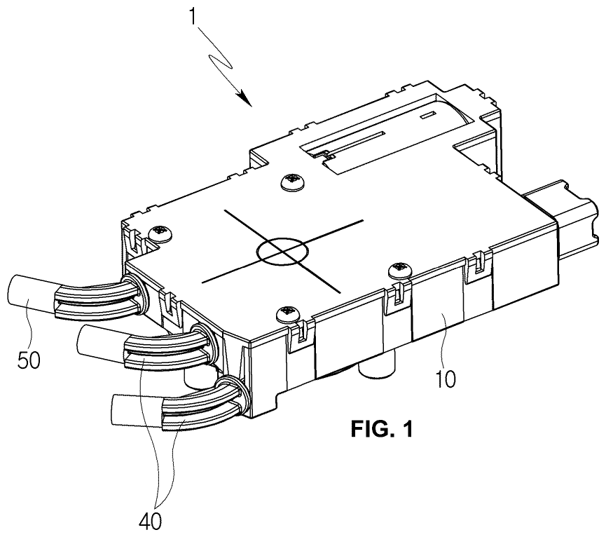

FIG. 2 is an exploded perspective view illustrating a release actuator of a vehicle seat illustrated in FIG. 1.

FIG. 3 is a perspective view illustrating a rotating unit, a first cable and a second cable illustrated in FIG. 2.

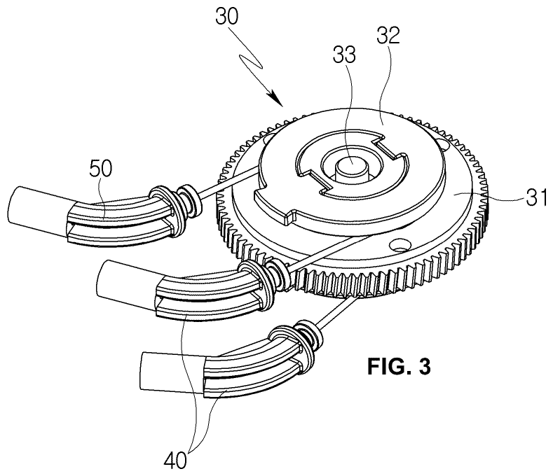

FIG. 4 is a bottom surface perspective view illustrating a rotating unit, a first cable and a second cable illustrated in FIG. 2.

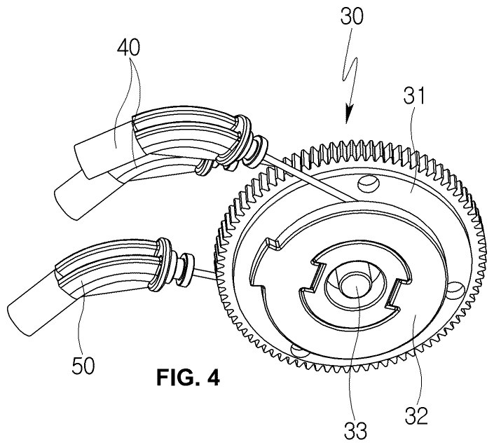

FIG. 5 is a side view of a rotating unit, a first cable and a second cable illustrated in FIG. 2.

FIG. 6 is a perspective view taken along section line A-A of FIG. 5.

FIG. 7 is a perspective view of a rotating unit illustrated in FIG. 3.

FIG. 8 is a bottom surface perspective view illustrating a rotating unit illustrated in FIG. 3.

FIG. 9 is a perspective view and a top view of a rotating gear illustrated in FIGS. 7 and 8.

FIG. 10 is a perspective view and a top view of a rotating ring illustrated in FIGS. 7 and 8.

The following component list and associated numbering found in the drawings is provided to assist in the understanding of one embodiment of the present invention:

| # | Component |
|---|---|
| 1 | Release actuator |
| 10 | Case |
| 20 | Driving unit |
| 21 | Electric motor |
| 22 | Worm gear |
| 30 | Rotating unit |
| 31 | Rotating gear |
| 32 | Rotating ring |
| 33 | Support axis |
| 40 | First cable |
| 41 | First end fitting |
| 50 | Second cable |
| 51 | Second end fitting |

It should be understood that the drawings are not necessarily to scale. In certain instances, details which are not necessary for an understanding of the invention or which render other details difficult to perceive may have been omitted. It should be understood, of course, that the invention is not necessarily limited to the particular embodiments illustrated herein.

### DETAILED DESCRIPTION

Hereinafter, exemplary embodiments of the present disclosure will be described in further detail with reference to the accompanying drawings.

A release actuator of a vehicle seat according to an embodiment of the present disclosure is configured to convert a walk-in locking mechanism and a folding locking mechanism into a released state from a locked state by means of a single device. At this instance, when the release actuator converts one among the walk-in locking mechanism and the folding locking mechanism into a released state from a locked state, the release actuator is configured to maintain the locked state of the remaining another one among the walk-in locking mechanism and the folding locking mechanism without influencing the remaining another one.

In addition, the walk-in locking mechanism to which the embodiment of the present disclosure is applied is provided at two positions in a single seat, and in general, the walk-in locking mechanism is installed in seat rails, respectively, on the left and right sides below the seat. In addition, the folding locking mechanism to which the embodiment of the present disclosure is applied is provided at one position in a single seat, and in general, the folding locking mechanism is installed on a side of a seat.

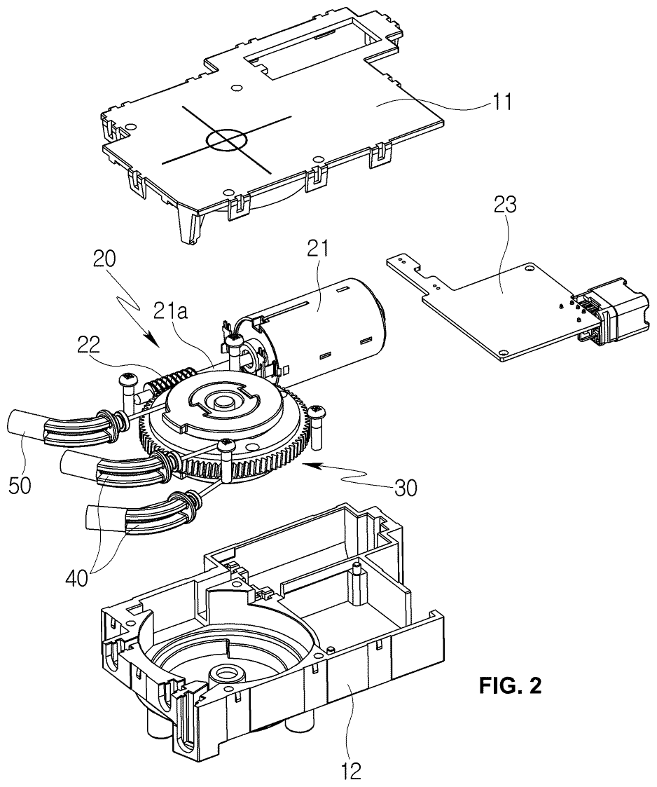

Referring to FIG. 2, the release actuator 1 of a vehicle seat according to an embodiment of the present disclosure includes a case 10, a driving unit 20, and a rotating unit 30.

In addition, the release actuator 1 of a vehicle seat according to an embodiment of the present disclosure further includes a first cable 40 connecting the walk-in locking mechanism and the rotating unit 30 to be interlocked with each other, and a second cable 50 connecting the folding locking mechanism and the rotating unit 30 to be interlocked with each other.

That is, the first cable 40 is installed between the walk-in locking mechanism and the rotating unit 30 and is configured to convert the walk-in locking mechanism into the released state from the locked state based on a rotational force provided from the rotating unit 30. In this case, a pair of the first cables 40 is provided between the walk-in mechanism and the rotating unit 30.

In addition, the second cable 50 is installed between the folding locking mechanism and the rotating unit 30 and is configured to convert the folding locking mechanism into the released state from the locked state based on a rotational force provided from the rotating unit 30. In this case, a single second cable 50 is provided between the folding locking mechanism and the rotating unit 30.

The case 10 is formed to have a shape accommodating each of the driving unit 20 and the rotating unit 30 therein. For example, the case 10 may be formed with an upper housing 11 and a lower housing 12 which are vertically divided and assemblable.

The driving unit 20 is installed inside the case 10, and is configured to selectively provide a rotational force in a forward/reverse direction to the rotating unit 30.

To this end, the driving unit 20 includes an electric motor 21 operating by power provided from an external device, and a worm gear installed on a rotational shaft 21a of the electric motor 21 and configured to provide a rotational force to the rotating unit 30.

In addition, the driving unit 20 further includes a circuit board 23 configured to control an operating state by receiving an operation signal from an external device and providing the signal to the electric motor 21 so as to properly control a rotational direction and a rotating speed etc. of a forward/reverse rotation of the electric motor 21.

The rotating unit 30 is a member configured to implement a forward rotation or a reverse rotation by an actuation force provided by the driving unit 20, and is configured to generate tension by providing a rotational force selectively to at least one among the first cable 40 and the second cable 50.

For example, when the tension is provided by the rotating unit 30 to the first cable 40 based on a forward rotation, the tension is not provided to the second cable 50. Reversely, when the tension is provided by the rotating unit 30 to the second cable 50 based on a reverse rotation, the tension is not provided to the first cable 40.

To this end, the rotating unit 30 includes a forward interlocking rotating part configured to provide tension to one among the first cable 40 and the second cable 50 based on a forward rotation; and a reverse interlocking rotating part configured to provide tension to another one among the first cable 40 and the second cable 50 based on a reverse rotation. At this instance, it is preferable that the forward interlocking rotating part and the reverse interlocking rotating part are configured to be set in directions opposite to each other based on a rotational direction of the rotating unit 30.

To describe it additionally, the rotating unit 30 is configured to apply tension independently to one cable among the first cable 40 and the second cable 50. At this instance, a direction in which the tension is applied is determined based on the rotational direction of the rotating unit 30. That is, the forward interlocking rotating part serves to provide tension to one among the first cable 40 and the second cable 50, and the reverse interlocking rotating part serves to provide tension to remaining another one among the first cable 40 and the second cable 50.

In addition, the rotating unit 30 include a forward-reverse interlocking invalid section configured to not to provide tension to the first cable 40 and the second cable 50, respectively, in a forward direction and a reverse direction and disposed between the forward interlocking rotating part and the reverse interlocking rotating part.

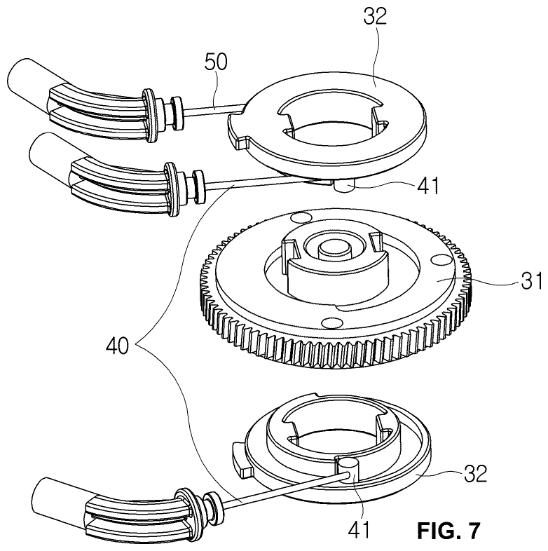

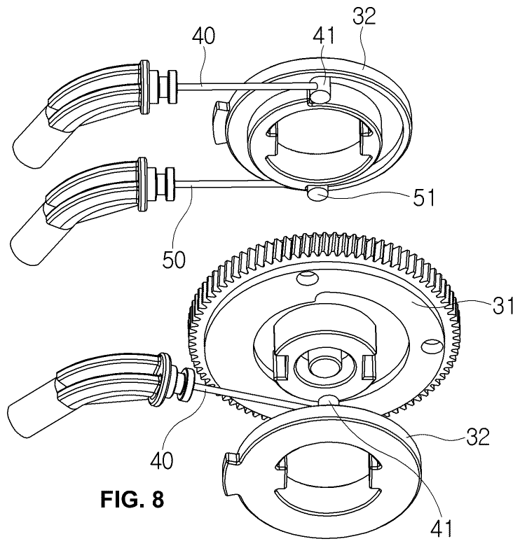

Referring to FIGS. 7 to 10, the rotating unit 30 includes a rotating gear 31 configured to rotate by receiving a rotational force from the driving unit 20, a rotating ring 32 installed coaxially with a rotational center of the rotating gear 31 and configured to set the forward interlocking rotating part and the reverse interlocking rotating part, and a support axis 33 configured to install the rotating gear 31 to be rotatable with respect to the case 10.

At this instance, a single rotating gear 31 is preferably provided. On contrary, a pair of rotating rings 32 are preferably provided. In particular, it is more preferable that the rotating rings 32 are installed in a shape overlapping each other in a coaxial layered arrangement structure on both side surfaces about the rotating gear 31.

In this case, the rotating gear 31 includes a body part 310, and a boss part 311 provided in the body part 310. For example, the body part 310 may be formed with a member having a disk shape and a boss part 311 may be formed with a member protruding outward from a center of the body part 310. In addition, the rotating gear 31 includes a tooth part 310a configured to provide power to the driving unit 20 and disposed along an outer circumferential surface of the body part over the entire circumference. That is, the tooth part 310a is tooth-engaged with the driving unit 20 and the worm gear 22.

In addition, the rotating ring 32 includes a body part 320, and a boss part 321 provided in the body part 320. For example, the body part 320 may be formed with a member having a disk shape and a boss part 321 may be formed with a member protruding outward from a center of the body part 320.

At this instance, it is preferable that the boss part 311 of the rotating gear 31 and the boss part 321 of the rotating ring 32 are disposed at positions opposite to each other about the rotating gear 21.

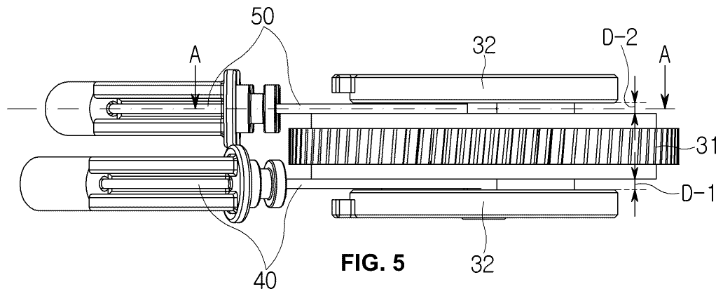

Referring to FIG. 5, the rotating unit 30 is configured to form a first gap D-1 disposed between one side surface of the rotating gear 31 and a surface of one among the rotating rings 32 opposite to the one side surface and spacing them apart at a proper interval so as to allow insertion of the first cable 40 thereinto. Further, the rotating unit 30 is configured to form a second gap D-2 disposed between another side surface of the rotating gear 31 and a surface of another one among the rotating rings 32 opposite to the another side surface and spacing them apart at a proper interval so as to allow insertion of the second cable 50 thereinto.

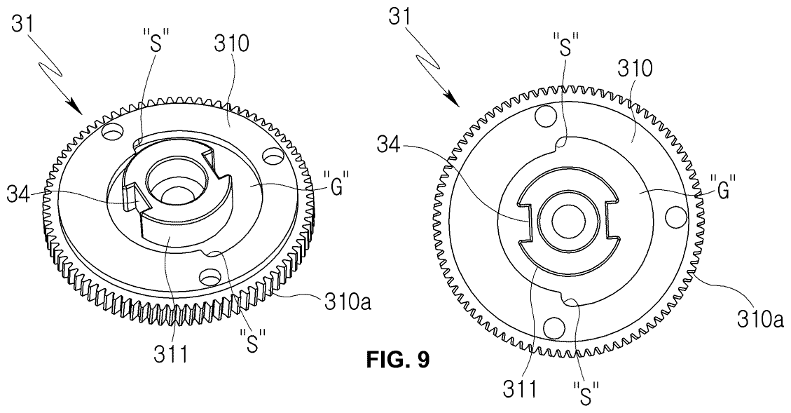

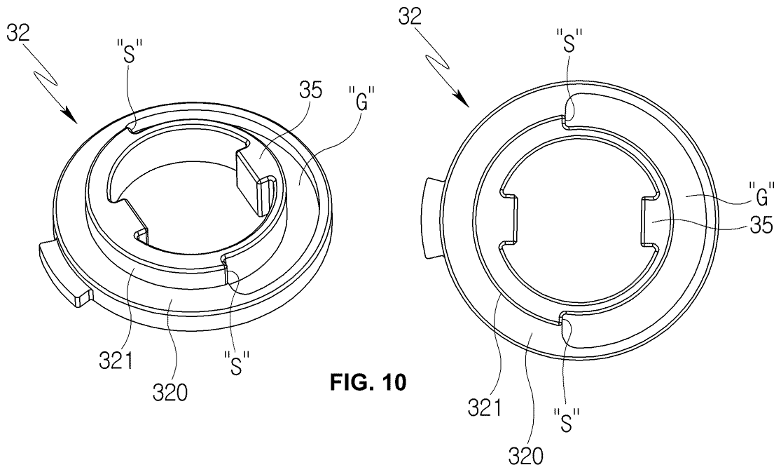

In addition, as illustrated in FIGS. 9 and 10, the rotating unit 30 further includes a shaft coupling unit configured to coaxially install the rotating gear 31 and the rotating ring 32 and integrally connect a portion between the rotating gear 31 and the rotating ring 32. At this instance, the shaft coupling unit may be formed with a recessed groove 34 and a protrusion 35 configured to coaxially couple the boss part 311 of the rotating gear 31 and the boss part 321 of the rotating ring 32 to each other with respect to the rotational center of the rotating unit 30.

For example, the recessed groove 34 may be formed on an outer circumferential surface of boss part 311 of the rotating gear 31, and the protrusion 35 may be formed on an inner circumferential surface of the boss part 321 of the rotating ring 32, and the recessed groove 34 and the protrusion 35 may take a form in that the protrusion 35 is inserted into the recessed groove 34.

Meanwhile, in the embodiment of the present disclosure, as illustrated in FIGS. 9 and 10, the forward interlocking rotating part, the reverse interlocking rotating part and the forward-reverse interlocking invalid section include an arcuate groove portion G provided in each of the rotating gear 31 and the rotating ring 32 and a stepped portion S stepped and provided in each of both ends of the arcuate groove portion G.

At this instance, the arcuate groove portion G is configured to movably accommodate a free end of the first cable 40 and a free end of the second cable 50 therein. In addition, the stepped portion S is configured to contact and restrict the free end of the first cable 40 and the free end of the second cable 50 so that moving is impossible.

For example, the arcuate groove portion G may be disposed along a circumference of the boss part 311 of the rotating gear 31 in the body part 310 of the rotating gear 31. Further, the arcuate groove portion G may be disposed along a circumference of the boss part 321 of the rotating ring 32 in the body part 320 of the rotating ring 32.

At this instance, the arcuate groove portion G is configured such that the arcuate groove portion G is stacked continuously with a same radius of curvature with respect to the rotational center of the rotating unit. Moreover, the arcuate groove portion G is configured to movably accommodate each of a first end fitting 41 provided in the free end of the first cable 40 and a second end fitting 51 provided in the free end of the second cable 50 therein.

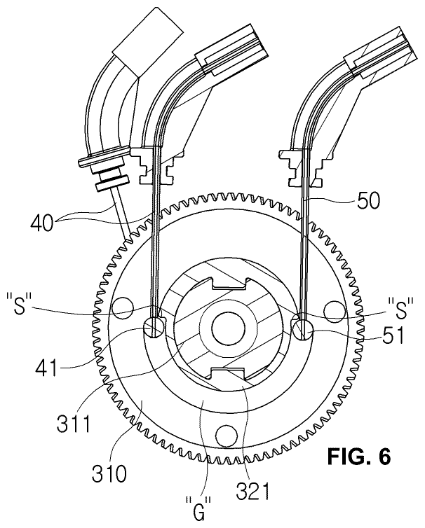

That is, as illustrated in FIGS. 6 to 8, the first end fitting 41 is provided in the free end of the first cable 40, is movable along the arcuate groove portion G and is configured to restrict moving through a contact with the stepped portion S. In addition, the second end fitting 51 is provided in the free end of the second cable 50, is movable along the arcuate groove portion G and is configured to restrict moving through a contact with the stepped portion S. In this case, the first end fitting 41 and the second end fitting 51 may be formed to have a cylindrical plug shape.

To summarize, the arcuate groove portion G and the stepped portion S are configured such that they allow or release restriction with respect to the first end fitting 41 and the second end fitting 51 according to a rotational direction of the rotating unit 30, so that tension is provided or not provided to the corresponding cable.

For example, when the rotating unit 30 rotates in a forward direction, the stepped portion S positioned at a starting point of the rotational direction among the stepped portion S can provide tension to the first cable 40 through a contact with the first end fitting 41. Over the course, the stepped portion S positioned at an ending point of the rotational direction of the stepped portion S becomes not in contact with the second end fitting 51, therefore, does not provide tension to the second cable 50.

Reversely, when the rotating unit 30 rotates in a reverse direction, the stepped portion S positioned at a starting point of the rotational direction among the stepped portion S can provide tension to the second cable 50 through a contact with the second end fitting 51. Over the course, the stepped portion S positioned at an ending point of the rotational direction of the stepped portion S becomes not in contact with the first end fitting 41, therefore, does not provide tension to the first cable 40.

Therefore, according to the embodiment of the present disclosure, tension can be provided to at least one among the first cable 40 and the second cable 50 according to the rotational direction of the rotating unit 30, therefore, it is possible to selectively convert only one among the walk-in locking mechanism and the folding locking mechanism from the locked state to the released state.

As a result, the embodiment of the present disclosure can reduce a quantity of parts needed in configuring a device for converting an operation of the walk-in locking mechanism and the folding locking mechanism and can save the manufacturing cost.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A release actuator of a vehicle seat, comprising:
a pair of first cables installed to release a walk-in locking mechanism;
a second cable installed to release a folding locking mechanism;
a rotating unit configured to apply tension independently and respectively to the first cable and the second cable based on a forward rotation and a reverse rotation; and
a driving unit configured to provide a rotational force to the rotating unit in a forward direction and a reverse direction,
wherein the rotating unit includes a forward interlocking rotating part configured to provide tension to one among the first cable and the second cable based on a forward rotation; and a reverse interlocking rotating part configured to provide tension to another one among the first cable and the second cable based on a reverse rotation, and
wherein the forward interlocking rotating part and the reverse interlocking rotating part are configured to be set in directions opposite to each other based on a rotational direction of the rotating unit.

2. The release actuator of claim 1, wherein a forward-reverse interlocking invalid section configured to not to provide tension to the first cable and the second cable, respectively, in a forward direction and a reverse direction is provided between the forward interlocking rotating part and the reverse interlocking rotating part.

3. The release actuator of claim 2, wherein the rotating unit includes a rotating gear receiving a rotational force from the driving unit, and a rotating ring installed coaxially with a rotational center of the rotating gear and configured to set the forward interlocking rotating part and the reverse interlocking rotating part.

4. The release actuator of claim 3, wherein the rotating ring consists of at least a pair of members installed in a coaxial layered arrangement structure on both side surfaces about the rotating gear.

5. The release actuator of claim 4, wherein the rotating gear includes a body part having a disk shape and a boss part protruding outward from a center of the body part, and the rotating ring includes a body part having a disk shape and a boss part protruding outward from a center of the body part, and
wherein the boss part of the rotating gear and the boss part of the rotating ring are disposed at positions opposite to each other about the rotating gear.

6. The release actuator of claim 5, wherein the rotating gear includes a tooth part configured to provide power to the driving unit and disposed along an outer circumferential surface of the body part.

7. The release actuator of claim 5, wherein the rotating unit includes a first gap allowing the first cable to be inserted thereinto and disposed between one side surface of the rotating gear and a surface of one among the rotating rings opposite to the one side surface, and a second gap allowing the second cable to be inserted thereinto and disposed between another side surface of the rotating gear and a surface of another one among the rotating rings opposite to the another side surface.

8. The release actuator of claim 7, wherein the rotating unit further includes a shaft coupling unit configured to coaxially connect the rotating gear and the rotating ring.

9. The release actuator of claim 8, wherein the shaft coupling unit includes a recessed groove and a protrusion configured to coaxially couple the boss part of the rotating gear and the boss part of the rotating ring to each other with respect to the rotational center of the rotating unit.

10. The release actuator of claim 9, wherein the recessed groove is formed on an outer circumferential surface of boss part of the rotating gear, and the protrusion is formed on an inner circumferential surface of the boss part of the rotating ring.

11. The release actuator of claim 5, wherein the forward interlocking rotating part, the reverse interlocking rotating part and the forward-reverse interlocking invalid section include an arcuate groove portion provided in each of the rotating gear and the rotating ring and a stepped portion provided in each of both ends of the arcuate groove portion, and
wherein the arcuate groove portion movably accommodates a free end of the first cable and a free end of the second cable therein, and the stepped portion is configured to contact and restrict the free end of the first cable and the free end of the second cable.

12. The release actuator of claim 11, wherein the arcuate groove portion is provided on a circumference of the boss part of the rotating gear in the body part of the rotating gear, and on a circumference of the boss part of the rotating ring in the body part of the rotating ring, and
wherein the arcuate groove portion is stacked continuously with a same radius of curvature with respect to the rotational center of the rotating unit.

13. The release actuator of claim 11, wherein each of a first end fitting provided in the free end of the first cable and a second end fitting provided in the free end of the second cable are movably inserted into the arcuate groove portion, and are installed to be in contact with the stepped portion.
